(19) United States
(12) Patent Application Publication
(10) Pub. No.: US 2020/0159178 A1
(43) Pub. Date: May 21, 2020

(54) Vertical Farm System And Method

(71) Applicant: Ben Harris, Columbia, MO (US)

(72) Inventor: Ben Harris, Columbia, MO (US)

(21) Appl. No.: 16/522,639

(22) Filed: Jul. 25, 2019

Related U.S. Application Data
(60) Provisional application No. 62/703,369, filed on Jul. 25, 2018.

(51) Int. Cl. G05B 19/042

(52) U.S. Cl. CPC G05B 19/042; G05B 2219/2625

(57) ABSTRACT

A control system of a vertical faun includes a machine vision system providing plant health feedback of one or more plants of the vertical farm; a processor and memory programmed to provide output control of light, water, and atmospheric conditions supplied to the one or more plants based, at least partially, on the machine vision plant health feedback; an input system providing weighted feedback control of light sensors, water sensors, and atmospheric condition sensors; and wherein the memory is dynamically updated to provide an optimal output control of the light, the water, and the atmospheric conditions supplied to the one or more plants based on the machine vision plant health feedback and the weighted feedback control of the light sensors, the water sensors, and the atmospheric condition sensors.

### RELATED APPLICATIONS

This application claims priority to a U.S. provisional application 62/703,369 titled “Vertical Farm System And Method” filed on Jul. 25, 2018. The provisional application is hereby incorporated by reference, in its entirety, for all it discloses and conveys.

### FIELD OF THE INVENTION

The present invention relates generally to a control system. More specifically, the present invention is a control system for a vertical farming system.

### SUMMARY

A control system of a vertical farm includes a machine vision system providing plant health feedback of one or more plants of the vertical faun; a processor and memory programmed to provide output control of light, water, and atmospheric conditions supplied to the one or more plants based, at least partially, on the machine vision plant health feedback; an input system providing weighted feedback control of light sensors, water sensors, and atmospheric condition sensors; and wherein the memory is dynamically updated to provide an optimal output control of the light, the water, and the atmospheric conditions supplied to the one or more plants based on the machine vision plant health feedback and the weighted feedback control of the light sensors, the water sensors, and the atmospheric condition sensors.

The optimal light output control may include one or more of light intensity, wavelength, duty cycle, or a combination thereof. The optimal output control of the water may include one or more of water P.H., water temperature, a water temperature gradient over a time period, water pressure, water volume flow, water height levels, electrical conductivity of water, or a combination thereof. The optimal output control of the atmospheric conditions may include one or more of atmospheric levels of CO2, humidity, atmospheric temperature, or a combination thereof The machine vision system may use one or more cameras. The control system may further comprise dynamically controllable lighting. The processor may dynamically change intensity, wavelength, or duty cycle of the dynamically controllable lighting. The machine vision system may provide plant health feedback of two or more plants of the vertical faire. Each of the two or more plants may be individually controlled and monitored. Each of the two or more plants may be individually controlled with separate weighted feedback. The machine vision system may provide individualized plant health feedback for each of the two or more plants. The machine vision plant health feedback may be a function of time. The machine vision plant health feedback may be a function of plant color. The machine vision plant health feedback may be a function of plant size. The machine vision plant health feedback may be a function of plant color change over time. The machine vision plant health feedback may be a function of plant size over time. The machine vision plant health feedback may be a function of plant size change and plant color change over time. The weighted feedback control may be a function of plant size change over time. The weighted feedback control may be a function of plant color change over time. The weighted feedback control is a function of plant size change and plant color change over time. The control system may be used on a river barge vertical farm or an ocean floating vertical farm.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a control system and method in accordance with an embodiment of the invention;

FIG. 2 shows a control system and method in accordance with an embodiment of the invention

FIG. 3 shows a modular farming device in accordance with an embodiment of the invention;

FIG. 4 shows an array of modular farming devices in accordance with an embodiment of the invention;

FIG. 5 shows an assembly of a modular farming device in accordance with an embodiment of the invention;

FIG. 6 shows an array of modular farming devices in accordance with an embodiment of the invention;

FIG. 7 shows an array of modular farming devices in accordance with an embodiment of the invention;

FIG. 8 shows an array of floating modular farming devices in accordance with an embodiment of the invention;

FIG. 9 shows a trinity tower power system in accordance with an embodiment of the invention;

FIG. 10 shows a trinity tower power system of in accordance with an embodiment of the invention; and

FIG. 11 shows a sea born version of a vertical faint system in accordance with an embodiment of the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention but is merely representative of certain examples of presently contemplated embodiments in accordance with the invention. The presently described embodiments will be best understood by reference to the drawings.

In some instances, features represented by numerical values, such as dimensions, mass, quantities, and other properties that can be represented numerically, are stated as approximations. Unless otherwise stated, an approximate value means “correct to within 50% of the stated value.” Thus, a length of approximately 1 inch should be read “1 inch +/−0 0.5 inch.”

All or part of the present invention may be embodied as a system, method, and/or computer program product. The computer program product may include a computer readable storage medium (or media) having computer readable program instructions thereon for causing a processor to carry out aspects of the present invention. For example, the computer program product may include firmware programmed on a microcontroller.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, a chemical memory storage device, a quantum state storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming languages such as Smalltalk, C++ or the like, and conventional procedural programming languages such as the “C” programming language or similar programming languages. Computer program code for implementing the invention may also be written in a low-level programming language such as assembly language.

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

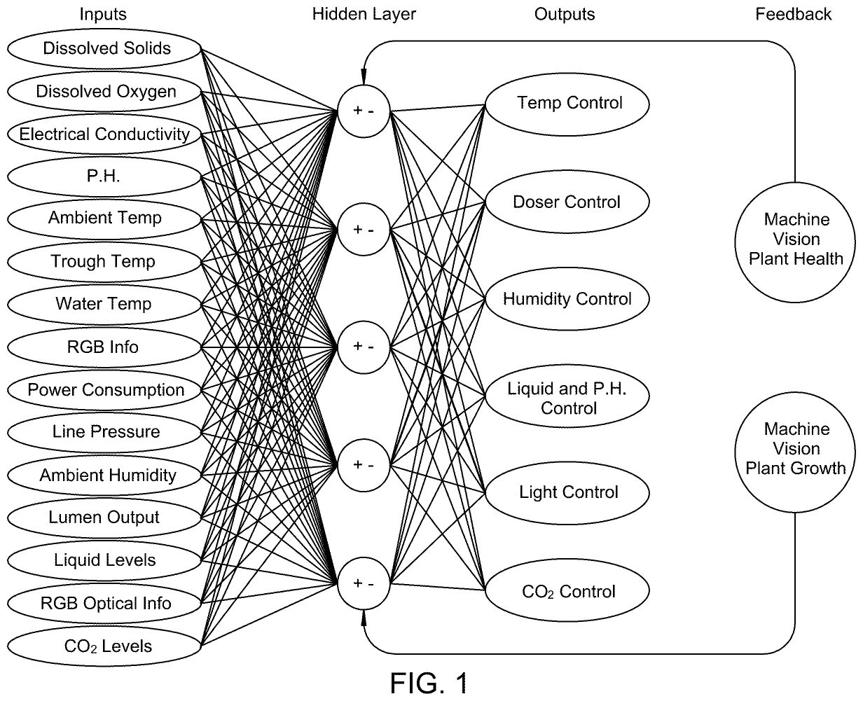

In FIG. 1, a feed-forward control system 100 is shown with an input layer, a hidden layer (dynamic algorithms), an output layer, and a feedback layer. The feedback layer consists of machine vision systems that detects changes in plant health over time (changes in color, changes in texture, changes in optical characteristics, changes in spectral characteristics, changes in nutrient density, changes in moisture content) and changes in plant growth characteristics over time (changes in texture, changes in size, changes in nutrient density, changes in moisture content). Changes in plant health data and plant growth data is used as feedback to dynamically change and update algorithms in the hidden layer.

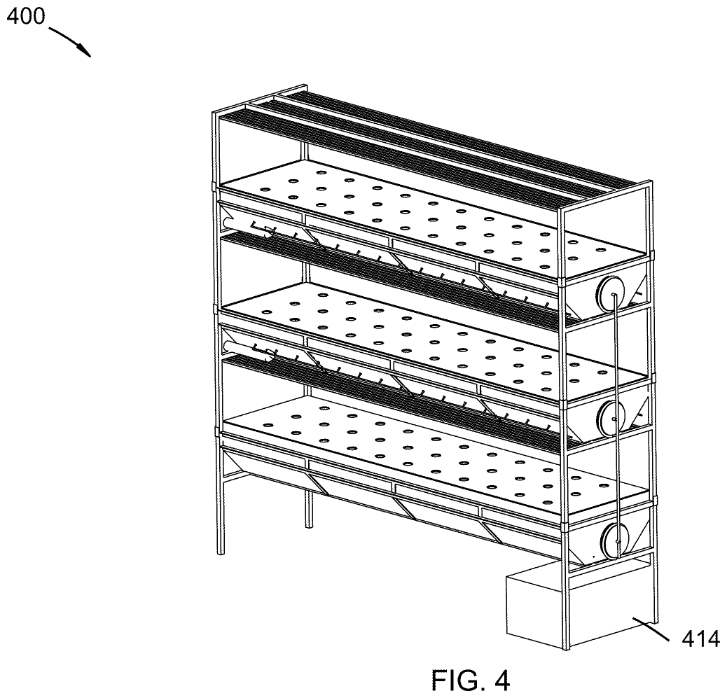

Outputs of temperature, dosing, humidity, liquid, P.H., lighting, and CO2 are dynamically controlled by one or more algorithms in the hidden layer. Weighted variables within the hidden layer algorithms are optimized, over time, in relation to a specific plant or plant type within the vertical farming system. Dynamic control parameters are updated and stored based on positive feedback from the machine vision feedback systems. Machine vision systems may be mechanically attached to a frame system with the ability to traverse multiple plants and multiple modular sections of vertically stacked farm system shown in FIG. 4. Machine vision systems may be, additionally or alternatively, disconnected from a frame structure of a single module or stacked sections of a vertically stacked farm system. Temperature control may include ambient temperature control, water temperature control, plant temperature control, temperature control based on a time-of-day, trough temperature control, and temperature monitoring. Doser control may include nutrient concentrations in the watering system, water line pressure control, water volume control, and watering frequency control. Humidity control may include ambient humidity control, trough humidity control, plant humidity control, and humidity monitoring. Liquid and P.H. control may include P.H control of spray water, liquid storage levels, nutrient storage levels, liquid storage temperatures of liquid nutrients, liquid mixing control, and P.H monitoring. Light control may include intensity control, light dosing control, light spectrum control, light timing control (light dosing), and light monitoring. CO2 control may include CO2 pressure control, CO2 concentration control, CO2 purging control, and CO2 monitoring.

Inputs may be from temperature sensors, optical sensors, cameras, CCDs, P.H. sensors, resistive sensors, pressure transducers, capacitive sensors, inductive sensors, reactive sensors, level sensors, float sensors, switches, phototransistors, mass flow detectors, spectrometers, electro-mechanical sensors, and micro-fluidic sensors.

Multiple hidden layer algorithms may be simultaneously implemented providing additional feedback from each algorithm to the other algorithms allowing for faster optimization of the learning control system 100. Machine vision system feedback may be used to update one or more weighted variables within one or more of the hidden layer algorithms.

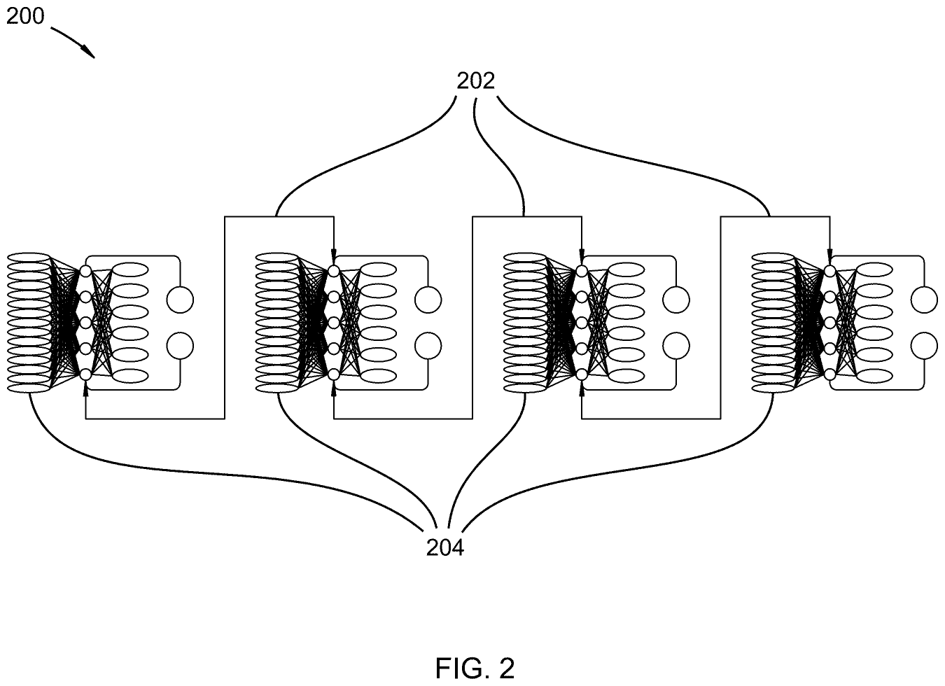

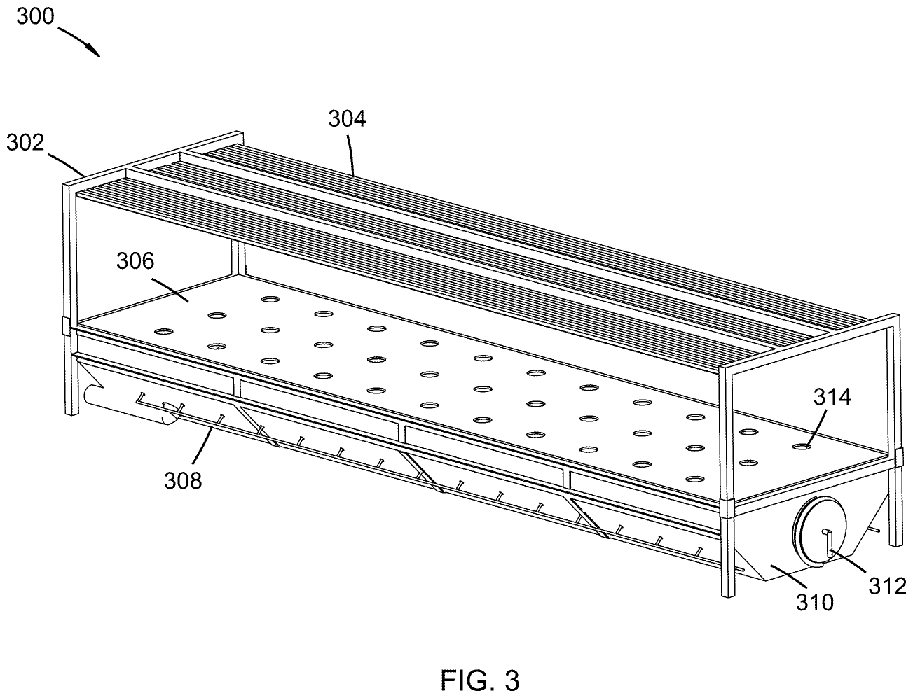

FIG. 2 shows a network 200 of feed-forward control systems connected together providing additional feedback 202 compared to a single feed-forward system (FIG. 1). Each of the feed-forward control systems 204 may have different starting weighted variables and provide feedback 202 to each other allowing an optimized plant control system to be learned faster. For example each of the control systems 204 may be connected to a single module plant faun 300 of a vertical plant faun system 400 (see FIGS. 3 & 4). Some of the inputs and some of the outputs may be shared within the network system, but the starting weighted variables of each hidden layer may be different allowing for faster data gathering and data sharing 202 among the network 200 of feed-forward systems.

FIG. 3 shows a single module plant farm 300 of a vertical plant faun system in accordance with the present invention. Modular plant faun system 300 includes a lighting system 304, a frame system 302, a plant support plate 306, holes 314, liquid spray system 308, trough 310, control system (not shown), supply system (not shown) and heat exchange system 312. Lighting system 304 includes one or more lights 304. Lights 304 may be LED, florescent, and/or incandescent. Lighting system 304 may control spectral radiation, light timing (light dosing), luminance, and/or power delivered to plants growing on plant support system 306. Frame system 302 is designed to be a stackable modular frame allowing multiple modular plant farms systems 300 to be stacked in a vertical fashion as shown in FIG. 4. Machine vision systems may be mechanically attached to a frame system with the ability to traverse multiple plants and multiple modular sections of vertically stacked farm system shown in FIG. 4. Machine vision systems may be, additionally or alternatively, disconnected from a frame structure of a single module or stacked sections of a vertically stacked farm system. Frame system 302 supports plant support plate 306, liquid spray system 308, trough 310, and heat exchange system 312. Plant support plate 306 includes plant holes 314 which create a through hole from a top side of plate 306 to an inside area of trough 310. Frame system 302 may provide support for the machine vision systems including cameras, spectrophotometers, etc. Liquid spray system 308 includes pressurized sprayers positioned within trough 310 and connected to a common pressurized water supply delivery tube shown at 308. Water supply tube 308 is connected to a first end of a first coil of heat exchange system 312. The second end of the first coil of heat exchange system 312 is connected to a pump which creates pressure needed to deliver water to plant roots within trough 310 by way of spray nozzles attached to supply line 308. Heat exchange system 312 includes a second coil for waste heat transfer. The second coil may be connected to a circulating water heat transfer system or another circulating liquid cooling/heating transfer system such as a glycol thermal transfer system. Trough 310 also includes one or more drain lines connectable to other stacked vertical modular farm systems. Drain lines may share a common drainage system and tank with multiple vertically stacked faun systems.

FIG. 4 shows a vertical plant farm system 400 including multiple modular vertical farm modules stacked on top of each other. A common drain (not shown) and common thermal waste line 424 may be used. A control system 414 including one or more processors, memory, wired and wireless communications, sensors, and programming may be housed in control box 414. Control box 414 may also house a common storage tank, a common waste heat system, a common pump and motor, and one or more sensors.

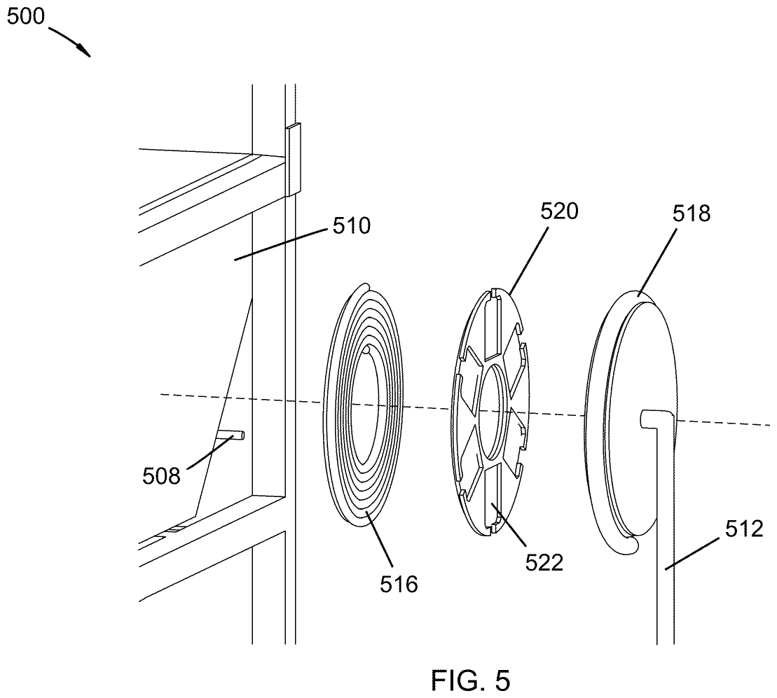

FIG. 5 shows an exploded view of the heat exchange system 500 (312 of FIG. 3). The heat system 500 includes a first heat exchange coil 516 including a first end and a second end, a heat exchange plate 520 including six recesses 522, a second heat exchange coil 518 including an input and/or output thermal waste port 524. Heat exchange system 500 is designed to control a temperature of pressurized supply water flowing through second coil 516 and water delivery line 508. Water delivery line 508 may be a common line connected to several sprayers within trough 510. Heat exchange plate 520 is designed to receive one or more thermal electric modules within recesses 522. The thermal electric modules can heat or cool supply water flowing through first coil 516 as needed. Waste heat/cooling from the thermal electric modules can be dissipated by circulation of liquid through second coil 518 and transfer line 524.

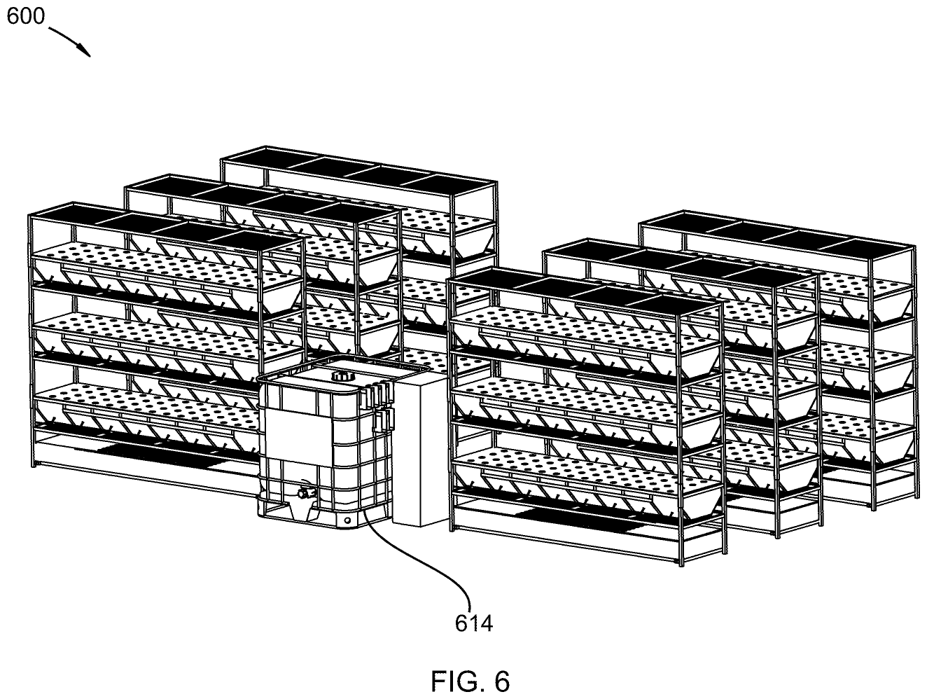

FIG. 6 shows a vertical plant farm system array 600 including multiple modular vertical farm modules stacked on top of each other in accordance with an embodiment of the invention. A control system 614 including one or more processors, memory, wired and wireless communications, sensors, and programming may be housed in control box 614. Control box 614 may also house a common storage tank, a common waste heat system, a common pump and motor, and one or more sensors.

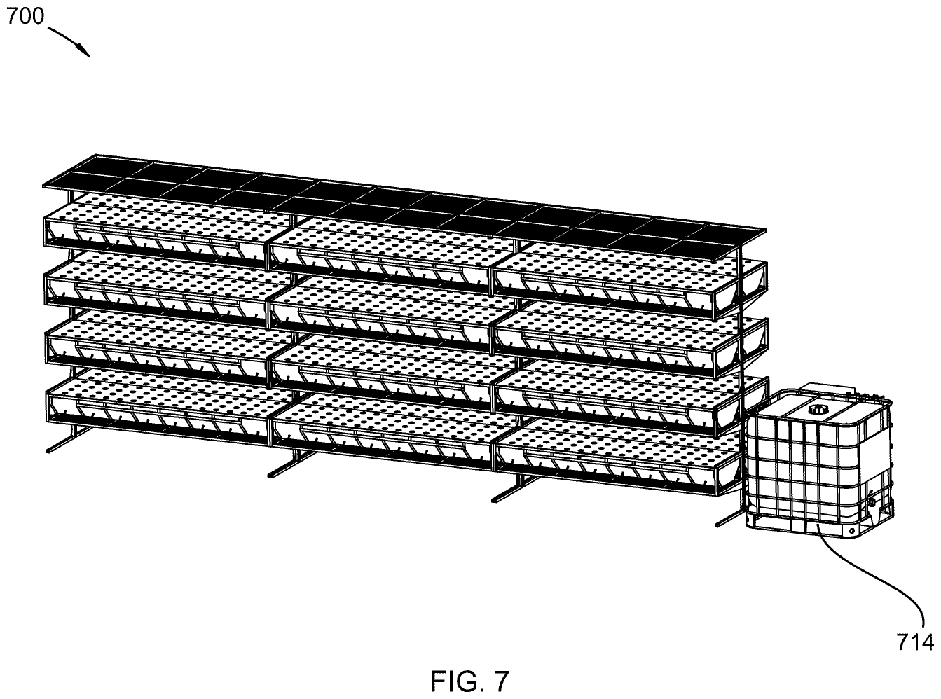

FIG. 7 shows a vertical plant faint system array 700 including multiple modular vertical farm modules stacked on top of each other in accordance with an embodiment of the invention. A control system 714 including one or more processors, memory, wired and wireless communications, sensors, and programming may be housed in control box 714. Control box 714 may also house a common storage tank, a common waste heat system, a common pump and motor, and one or more sensors.

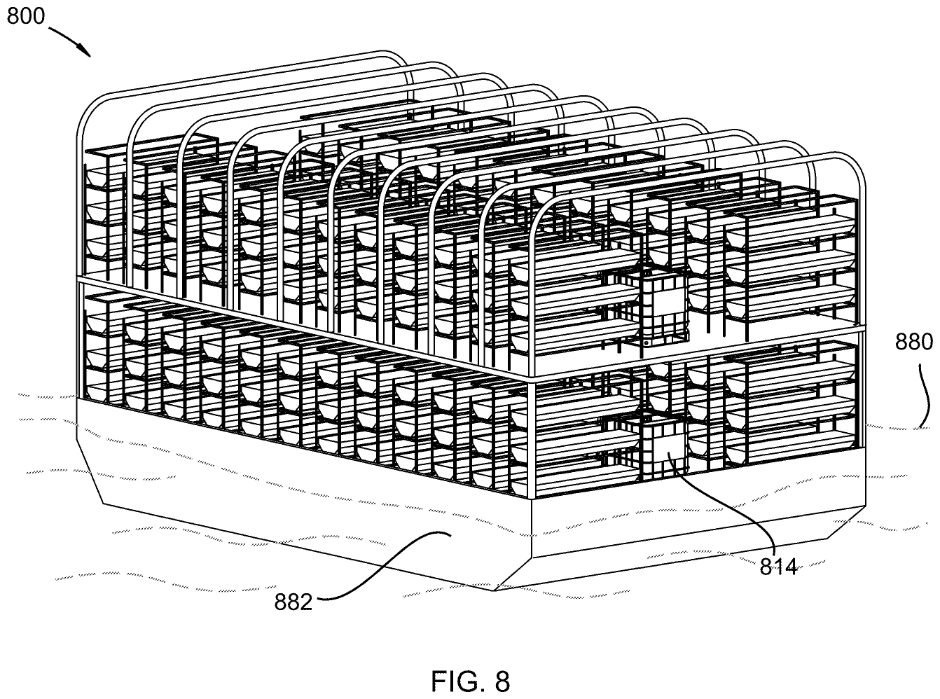

FIG. 8 shows a vertical plant farm system water array 800 including multiple modular vertical farm modules stacked on top of each other in accordance with an embodiment of the invention. A control system 814 including one or more processors, memory, wired and wireless communications, sensors, and programming may be housed in control box 814. Control box 814 may also house a common storage tank, a common waste heat system, a common pump and motor, and one or more sensors. Vertical plant farm system 800 may include a floating base frame 882. Floating base frame 882 may be similar to a pontoon boat base or barge which floats in water 880 and provides a sturdy, floating surface for vertical farm system 800. Water 880 may be a river, ocean, lake, pool, or any body of water.

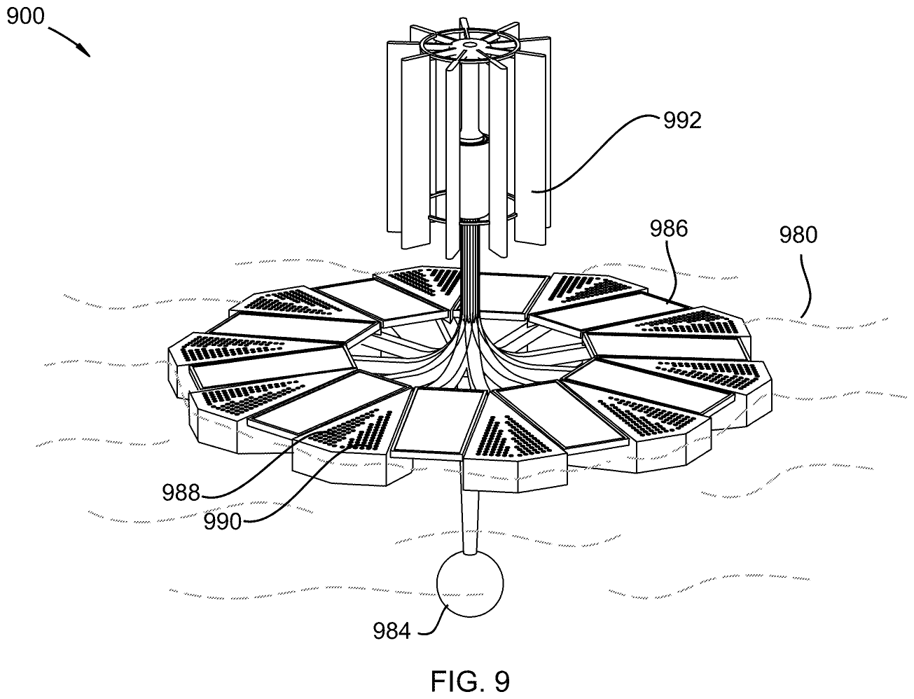

FIG. 9 shows a trinity tower power system 900 in accordance with an embodiment of the invention. Water 980 may be a river, ocean, lake, pool, or any body of water. Power system 900 may be used to power one or more vertical fauns similar to the floating vertical farm 800 shown in FIG. 8. Power system 900 includes battery banks 986. Battery banks 986 may include a plurality of individual battery cell which are each individually wired to a controller (not shown). The controller may be able to dynamically create sine waves by adding and subtracting battery cells in a series configuration. Individual cell may be added and subtracted to create a sine wave, isolate batteries for charging or discharging, isolate failing batteries, or to change voltage or current needs of a vertical fan I system. Multiple Power systems 900 may be used to support one or more vertical farms. Power system 900 also includes wave power generators 988/990. As waves 980 pass by paddles 988/990 may move up and down causing pressure to build up within pressure storage 984. Pressure in storage 984 may be used to turn one or more turbine generators by using excess exhaust pressure. Solar collectors may also be positioned on top surfaces of power system 900 (shown on top of paddles 988 and 990). Solar collectors may be used to charge one or more battery cells in battery banks 986. Ten or more battery banks 986 may be positioned in a circular pattern around power system 900. Ten or more solar collectors and wave generators may also be positioned in a circular pattern around power system 900. Pressure storage 984 may also be utilized as a counter weight to stabilized power system 900 in a river, ocean or other body of water 980. A wind turbine 992 may also serve to provide direct power to a vertical farm and/or in charging battery banks 986.

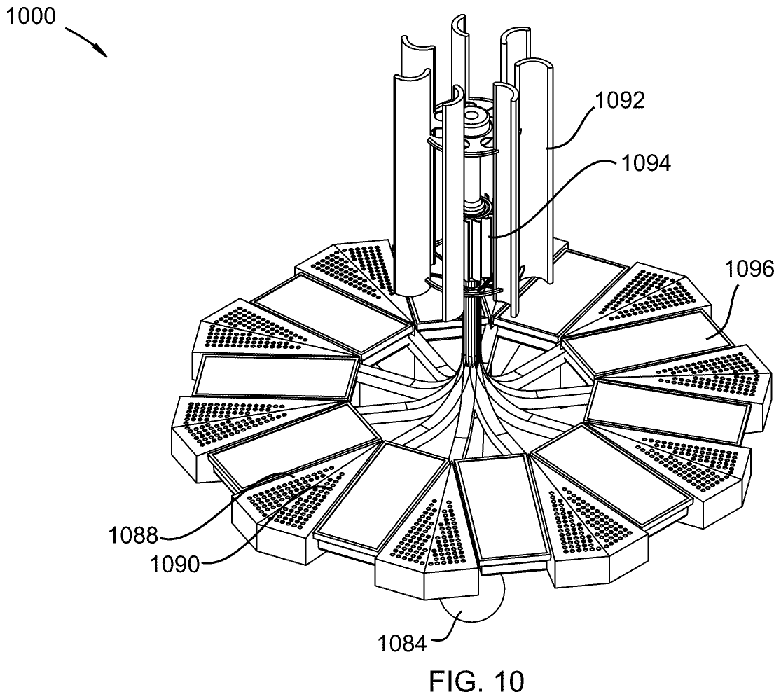

FIG. 10 shows a trinity tower power system 1000 in accordance with an embodiment of the invention. Power system 1000 may be used to power one or more vertical fauns similar to the floating vertical farm 800 shown in FIG. 8. Power system 1000 includes battery banks 1096. Battery banks 1096 may include a plurality of individual battery cell which are each individually wired to a controller (not shown). The controller may be able to dynamically create sine waves by adding and subtracting battery cells in a series configuration. Individual cell may be added and subtracted to create a sine wave, isolate batteries for charging or discharging, isolate failing batteries, or to change voltage or current needs of a vertical faun system. Multiple Power systems 900 may be used to support one or more vertical farms. Power system 1000 also includes wave power generators 1088/1090. Pressure in storage 1084 may be used to turn one or more turbine generators 1094 by using excess exhaust pressure. Solar collectors may also be positioned on top surfaces of power system 1000 (shown on top of paddles 1088 and 1090). Solar collectors may be used to charge one or more battery cells in battery banks 1096. Ten or more battery banks 986 may be positioned in a circular pattern around power system 900. Ten or more solar collectors and wave generators may also be positioned in a circular pattern around power system 1000. Pressure storage 1084 may also be utilized as a counter weight to stabilized power system 1000 in a river, ocean or other body of water. A wind turbine 1092 may also serve to provide direct power to a vertical farm and/or in charging battery banks 1096.

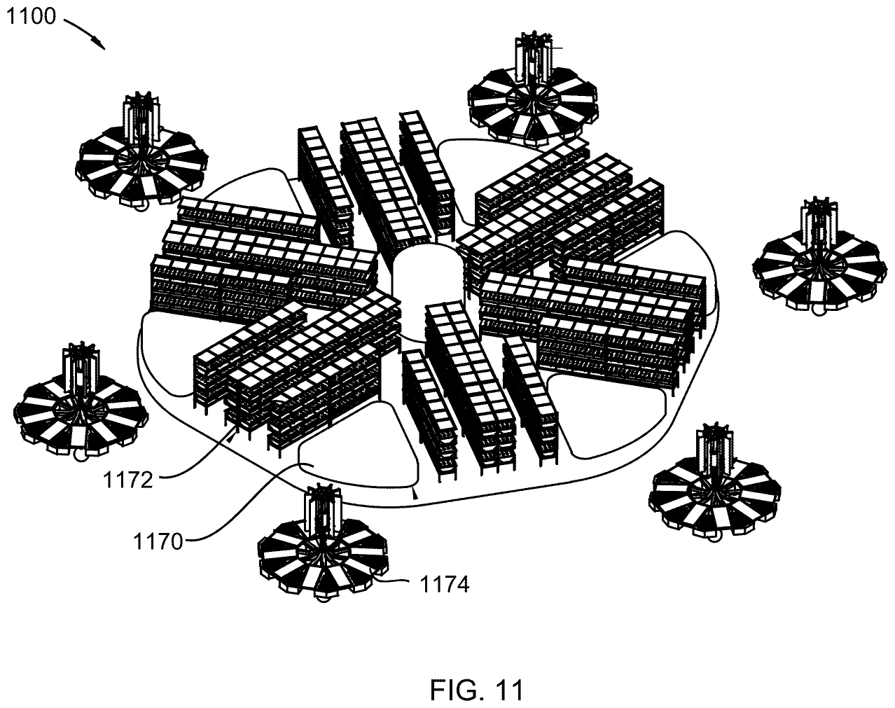

FIG. 11 shows a sea born version of a vertical farm system 1100 in accordance with an embodiment of the invention. Sea born vertical farm 1100 includes six trinity power stations 1174 similar to FIGS. 9 and 10. Power stations 1174 may be used to directly run vertical farm system 1172 or to charge batteries on each power station or to charge power storage areas 1170. Power storage areas 1170 may include salt water batteries, lead acid batteries, or other types of battery storage.

The systems and methods disclosed herein may be embodied in other specific forms without departing from their spirit or essential characteristics. The described embodiments are to be considered in all respects only as illustrative and not restrictive. All changes which come within the meaning and range of equivalency are to be embraced within their scope.

1. A control system of a vertical farm comprising:
a machine vision system providing plant health feedback of one or more plants of the vertical farm;
a processor and memory programmed to provide output control of light, water, and atmospheric conditions supplied to the one or more plants based, at least partially, on the machine vision plant health feedback;
an input system providing weighted feedback control of light sensors, water sensors, and atmospheric condition sensors; and
wherein the memory is dynamically updated to provide an optimal output control of the light, the water, and the atmospheric conditions supplied to the one or more plants based on the machine vision plant health feedback and the weighted feedback control of the light sensors, the water sensors, and the atmospheric condition sensors.

2. The control system of claim 1, wherein the optimal light output control includes one or more of light intensity, wavelength, duty cycle, or a combination thereof.

3. The control system of claim 2, wherein the optimal output control of the water includes one or more of water P.H., water temperature, a water temperature gradient over a time period, water pressure, water volume flow, water height levels, electrical conductivity of water, or a combination thereof.

4. The control system of claim 3, wherein the optimal output control of the atmospheric conditions includes one or more of atmospheric levels of CO2, humidity, atmospheric temperature, or a combination thereof.

5. The control system of claim 4, wherein the machine vision system uses one or more cameras.

6. The control system of claim 5 further comprising: dynamically controllable lighting.

7. The control system of claim 6, wherein the processor can dynamically change intensity, wavelength, or duty cycle of the dynamically controllable lighting.

8. The control system of claim 7, wherein the machine vision system provides plant health feedback of two or more plants of the vertical farm.

9. The control system of claim 8, wherein each of the two or more plants are individually controlled and monitored.

10. The control system of claim 9, wherein each of the two or more plants are individually controlled with separate weighted feedback.

11. The control system of claim 10, wherein the machine vision system provides individualized plant health feedback for each of the two or more plants.

12. The control system of claim 11, wherein the machine vision plant health feedback is a function of time.

13. The control system of claim 12, wherein the machine vision plant health feedback is a function of plant color.

14. The control system of claim 13, wherein the machine vision plant health feedback is a function of plant size.

15. The control system of claim 14, wherein the machine vision plant health feedback is a function of plant color change over time.

16. The control system of claim 15, wherein the machine vision plant health feedback is a function of plant size over time.

17. The control system of claim 16, wherein the machine vision plant health feedback is a function of plant size change and plant color change over time.

18. The control system of claim 17, wherein the weighted feedback control is a function of plant size change over time.

19. The control system of claim 18, wherein the weighted feedback control is a function of plant color change over time.

20. The control system of claim 19, wherein the control system is used on a river barge vertical farm or an ocean floating vertical farm.
